(19) United States
(12) Patent Application Publication
(10) Pub. No.: US 2014/0007045 A1
(43) Pub. Date: Jan. 2, 2014

(54) SYSTEMS AND METHODS FOR ENABLING CUSTOMIZATION OF VISUAL ELEMENTS BASED ON A SPECIFIED CLASS

(71) Applicant: Hans Muller, Saratoga, CA (US)

(72) Inventor: Hans Muller, Saratoga, CA (US)

(73) Assignee: Adobe Systems Incorporated, San Jose, CA (US)

(21) Appl. No.: 13/195,686

(22) Filed: Aug. 1, 2011

(51) Int. Cl. G06F 9/44

(52) U.S. Cl. 717/107

(57) ABSTRACT

One illustrative embodiment involves receiving input specifying a component in content being developed. The component, according to a definition of the component, comprises a visual element that is configurable based on type. The embodiment also involves receiving input specifying a type for the visual element. Visual or interactive characteristics of the visual element that are available for specification differ based on which type is specified for the visual element. The embodiment further involves providing the content. Such functionality can be implemented in an integrated development environment (IDE) which content developers can use to configure standard components such that they include additional visual or interactive characteristics not included in them at the time of their creation.

### TECHNICAL FIELD

Embodiments relate generally to software application development and more particularly to enabling enhanced customization of visual or interactive characteristics of a visual element.

### BACKGROUND

Persons developing content (content developers) in an integrated development environment (IDE), for example, are afforded access to a number of graphical components that can be used to develop content in the IDE. Examples of such components include buttons, list boxes, text boxes, and data grids. Components used in an IDE can be created within an IDE by a content developer, i.e., custom-built, or they can be standard components, for example, provided through a software development kit (SDK). Content developers who create their own components have flexibility and control in determining how their visual elements can be configured. Creating components, however, can be time-consuming, cumbersome, and inefficient in comparison to using existing, standard components. Using standard components, on the other hand, enables content developers to develop content more efficiently but with less flexibility.

A content developer can include components in a software application in various ways. For example, a content developer may use an IDE to select a component and place it at a desired location on a what-you-see-is-what-you-get (WYSIWYG) canvas area in the IDE. The IDE may display and allow editing of a graphical representation of the component and/or program code or markup that defines the visual or interactive characteristics of the component's visual elements. The content developer can view and modify the representation and characteristics to change or otherwise configure the visual elements of the component. When the content being developed is completed, the content developer exports, compiles, or otherwise provides the content for use by end users who can use the content, for example, to interact with displayed components and associated visual elements in the provided content.

While standard components can enable faster and more efficient development, they can also restrict a content developer's ability to configure visual elements of a component. For example, content developers who use standard components may be restricted to only being able to configure certain visual and/or interactive characteristics. For example, a content developer who desires to create an application that allows data to be entered into rows and columns can select and include a standard data grid component in the IDE. The IDE may display the data grid's visual elements and allow limited configuration of its visual elements based on the definitions of the component's visual elements, i.e., the specification of the standard data grid component provided in an SDK. A row separator visual element of a data grid, for example, may include certain configurable attributes and other attributes that are not configurable. A content developer may wish to change color and thickness attributes of the row separator but be unable to do so if those characteristics are not configurable. As another example, a content developer may desire for a row separator to have interactivity such that when an end user clicks on the row separator, informational text is displayed. Again, the content developer may be unable to specify such interactivity if configuring such interactivity is not permitted for the row separator visual element of the standard data grid component that is being used. Content developers desiring to configure such un-configurable characteristics have had to resort to the often inefficient, time-consuming, and cumbersome option of creating custom components themselves.

### SUMMARY

One illustrative embodiment involves receiving, at one or more processors, input specifying a component in content being developed. The component, according to a definition of the component, comprises a visual element that is configurable based on type. The embodiment also involves receiving, at one or more processors, input specifying a type for the visual element. Visual or interactive characteristics of the visual element that are available for specification differ based on which type is specified for the visual element. The embodiment further involves providing, via one or more processors, the content. This illustrative embodiment is mentioned not to limit or define the disclosure, but to provide an example to aid understanding thereof. Additional embodiments are discussed in the Detailed Description and further description is provided there.

### BRIEF DESCRIPTION OF THE FIGURES

These and other features, aspects, and advantages of the present disclosure are better understood when the following Detailed Description is read with reference to the accompanying drawings, where:

FIG. 1 depicts an exemplary computing environment for enabling customization of visual elements based on a type that is specified for the visual element.

FIG. 2 is a block diagram illustrating exemplary creation and use of visual elements in the exemplary computing environment of FIG. 1.

FIG. 3 is a flow chart illustrating a computer-implemented method for creating visual elements.

FIG. 4 is a flow chart illustrating an exemplary computer-implemented method for configuring visual elements based on type and providing a software application containing the configurable visual elements to an end user.

FIG. 5a depicts an exemplary data grid that includes a selection indicator prior to a type being specified for the selection indicator visual element.

FIG. 5b depicts an exemplary data grid that includes a selection indicator after a type has been specified for the selection indicator visual element.

FIG. 5c depicts an exemplary data grid that illustrates an increased area in response to the selection indicator visual element being expanded in a vertical direction.

FIG. 6 illustrates program code and markup associated with a selection indicator visual element.

FIG. 7 depicts an exemplary data grid that illustrates note paper visual elements that appear as cells in the exemplary data grid.

### DETAILED DESCRIPTION

Embodiments herein relate to enabling the configuration of visual elements based on type. Enabling such configuration involves creating visual elements in a fashion that enables them to be used flexibly by content developers, whether that use be in an IDE or via markup that is separate from the IDE. For example, a content developer may add a component to content being developed in an IDE and recognize that a particular aspect of a visual element of the component cannot be configured as the developer wishes. For example, the content developer may wish to change the color and size of a row separator visual element of a data grid component but be unable to make such configuration changes based on restrictions applicable to the visual element based on its particular type or class. The content developer is, however, able to change the type of the visual element so that the particular aspects of the visual component can be configured. In the above example, the content developer may change the type of the row indicator visual element to a different type such that the data grid visual element has different characteristics available for configuration, e.g., allowing the content developer to specify custom color and size attributes for the row indicator can be custom configured as desired.

The following examples further illustrate flexible use of component visual elements. In one example, a data grid component is again included in content being developed and the content developer recognizes that configuration of aspects of the data grid's selection indicator visual element are desired but unavailable. The selection indicator of the standard data grid component, in this example, is a visual element that highlights rows, columns, or cells of a component having such attributes, such as a data grid. The selection indicator of the standard data grid component used by the content developer may allow only certain of its attributes, such as color, to be configured. The content developer may, however, wish to configure the selection indicator to provide enhanced interactivity in a way not permitted based on the selection indicator's default type. In this example, the IDE content developer changes the selection indicator's type by changing the “class” of the selection indicator such that the selection indicator's definition (i.e., specifying its features and interactivity and how such features and interactivity may be configured) is inherited from a different parent object. For example, the change may result in the selection indicator inheriting its definition from parent class B rather than from parent class A. Inheriting from class B rather than class A provides the selection indicator with interactivity configuration options not available when it inherits from class A. As a specific example, inheriting from class B may allow the content developer to specify that the displayed corners of the selection indicator comprise displayed handles and to specify the appearance of such handles. Including and configuring such handles allows the content developer to specify interactivity that he/she otherwise could not, e.g., specifying the inclusion of the handles for an end user to click and drag to increase the size of a selected area. Additionally or alternatively, classes may also be specified so that the selection indicator, or another visual element, can inherit characteristics of those classes.

As another example, a content developer of an application that is targeted for a handheld tablet computer that does not have a mouse may desire to provide hover indicator-like functionality. In particular, instead of a message being displayed when a mouse is moved over a cell of a data grid, the content developer may want to enable such functionality when an end user navigates to a cell by pressing an arrow on a keyboard, i.e., caret indicator. The content developer can specify the hover indicator type for the caret indicator visual element such that when a user navigates to a cell using the tablet computer keypad, a message is displayed in similar fashion to that when a mouse is held over a cell using the hover indicator.

Types of other visual elements associated with a data grid component and other components can be specified to give greater control over their customization to content developers. Examples of visual elements associated with an exemplary data grid component include but are not limited to row and column background, row and column separator, hover indicator, caret indicator, selection indicator, and editor indicator. These visual elements can define the appearance and behavior of a data grid component. Other visual elements may also be included. Similarly, other components may have these and/or different visual elements associated therewith.

Content developers are able to change the characteristics available for configuration of a visual element by specifying a type for the visual element. In this way, the customization of visual elements is limited only by the number of available types. In one embodiment, any available type can be specified for any available visual element. To accomplish greater control over configurability, visual elements can be standardized in an SDK such that they include a limited number of characteristics, such as those defined in a base or primitive parent class from which the visual elements inherit. The visual elements of a component may be defined in the component's “skin,” in a portion of the component that defines the appearance or behavior of a component, or otherwise. The component and its associated visual elements may be defined in the SDK such that an IDE using the SDK recognizes that a type of the visual elements can be specified. In one exemplary embodiment, a type of a visual element is a configurable attribute of the visual element. For example, a type of the visual element may be specified by specifying the particular class from which the visual element inherits. In such an embodiment, the component and its associated visual elements may be defined in the SDK such that an IDE using the SDK recognizes that a class of the visual elements can be specified. The IDE may present a list of available classes from which a content developer can select to specify a particular class for a visual element. In doing so, the IDE may provide information about the class, e.g., providing text explaining that identification of class A allows configuration of features X, Y, Z, identification of class B allows configuration of features W, X, Y, Z, etc. A content developer may also use a markup language to specify a particular class for a visual element.

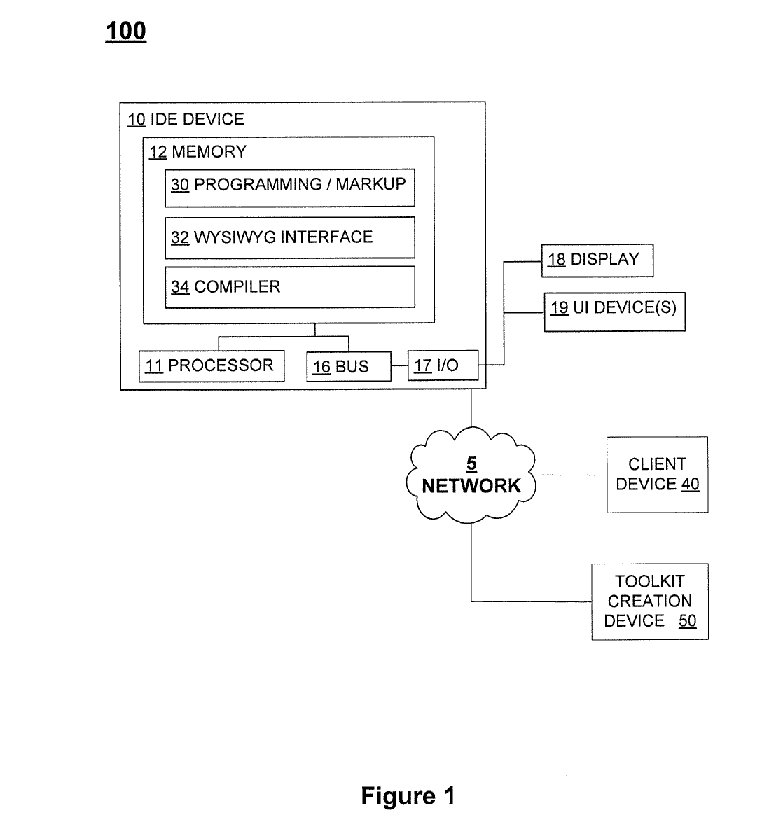

FIG. 1 depicts an exemplary computing environment for enabling configuration of visual elements based on a type that is specified for the visual element. The environment shown in FIG. 1 comprises a wired or wireless network 5 to which various devices or systems, specifically a device 10 that provides an IDE and a client device 40, are connected. In other embodiments, other networks, intranets, or combinations of networks may be used. Other embodiments do not involve a network and may, for example, provide features on a single device or on devices that are directly connected to one another, e.g., IDE device 10 may be directly connected to the client device 40. Other alternative networks, computers, and electronic device configurations are also possible. In one embodiment, the client device 40 can use the network 5 to download a software application or other content from the IDE device 10. The software application can be executed on the client device 40 where an end user can configure the visual elements. In another embodiment, the software application can be executed at the IDE device 10 by the client device 40 over the network 5. A toolkit creation device 50 can be used to create visual elements and include them in an SDK, in one embodiment. The visual elements can be downloaded from the toolkit creation device 50 to the IDE device 10 or another device for use in developing a software application.

As used herein, the term “device” refers to any computing or other electronic equipment that executes instructions and includes any type of processor-based equipment that operates an operating system or otherwise executes instructions. A device will typically include a processor 11 that executes program instructions and may include external or internal components such as a mouse, a CD-ROM, DVD, a keyboard, a display, or other input or output equipment. Examples of devices are personal computers, digital assistants, personal digital assistants, cellular phones, mobile phones, smart phones, pagers, digital tablets, laptop computers, Internet appliances, other processor-based devices, and television viewing devices. The exemplary IDE device 10 is used as a special purpose computing device to provide an IDE for creating software applications in a manner that enables enhanced configuration of visual elements. As used herein, an IDE is a software application that provides comprehensive facilities to content developers for software development. An IDE can include a source code editor and/or markup editor, a compiler and/or an interpreter, and build automation tools, e.g., a WYSIWYG interface and standard and custom-built components. IDE device 10 is illustrated in FIG. 1 with a display 18 and various user interface devices 19. A bus, such as bus 16, and an input/output device, such as device 17, will typically be included in a device such as the IDE device 10.

As used herein, the term “component” refers to an object comprising one or more visual elements that provide the appearance and behavior of the object. A component can be depicted as a graphic that can be used in a graphical user interface (GUI) application. Examples of components include a data grid, buttons, text boxes, list boxes, or other objects that enable a user to view or interact with a GUI application. A component can be standard or custom-built, according to various embodiments herein. A standard component can be created with standard or default characteristics for its visual elements and included in an SDK for use in an IDE. Custom-built components are considered to be components that are created by content developers using an IDE or markup language within or separate from the IDE.

As used herein, the term “visual element” refers to a displayed element of a component. A visual element can have configurable visual or interactive characteristics. Which characteristics of a visual element can be specified may depend upon which type the visual element is associated.

A data grid is an exemplary component that includes various visual elements. The visual elements of an exemplary data grid include row and column backgrounds, row and column separators, a hover indicator, a selection indicator, a caret indicator, and an editor indicator. Each of these visual elements provides unique characteristics for the exemplary data grid. For example, row and column backgrounds define the appearance of the background for each visible row and column in the data grid. The row or column separator divides rows and columns into cells. The hover indicator displays various information when a mouse is moved over certain portions of the data grid. The selection indicator highlights selected visible rows, columns, or cells. The caret indicator highlights the visible row, column, or cell that corresponds to keyboard input. The editor indicator highlights a cell that is being edited. Types and corresponding classes for each of these visual elements can be specified.

As used herein, a “type” refers to an attribute of a visual element that defines configurable visual or interactive characteristics. A “class” refers to a construct that is used as a blueprint to create instances of itself. Specifying a type for a visual element effectively specifies a class that corresponds to the type for the visual element. Specification of a class can enable a visual element to “inherit” the characteristics of the specified class such that the characteristics of the inherited class are passed to the visual element for which the class is specified. The characteristics are passed by deriving a new instance of the inherited class. New or additional characteristics for a visual element can be included in the derived instance of the inherited class.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, flash memory, or any other medium from which a computer processor can read instructions. The instructions may comprise processor-specific instructions generated by a compiler and/or an interpreter from code written in any suitable computer-programming language, including, for example, JavaScript, ActionScript®, Java, Perl, C, C++, C#, Visual Basic, and Python. The instructions may also be created using markup languages such as XML.

In FIG. 1, IDE device 10 comprises a memory 12 that contains various modules that can be used to configure visual elements based on type and create a software application containing the configurable visual elements in an IDE. Each of the modules can be implemented as individual modules that provide specific functionality. For example, a programming or markup language 30 can be used to create a software application that allows an end user to interact with the visual or interactive characteristics of the visual elements. The programming or markup language 30 can be included in an IDE or can be separate from an IDE. Content developers can specify, via a programming language such as ActionScript® or a markup language such as XML, one or more classes for a visual element so that the visual element can inherit the characteristics of the specified class. Other programming or markup languages can be used to specify the classes in other embodiments. An IDE can also include a WYSIWYG interface 32 and a compiler 34. The WYSIWYG interface 32 can allow content developers to select components and visual elements that will be included in a software application. A compiler 34 can be used to compile program code that is developed in ActionScript, for example, so that it can be executed by a user at the client device 40, according to one embodiment. The functionality provided by the programming or markup language 30, the WYSIWYG interface 32, and the compiler 34 can be provided by fewer or more modules in other embodiments.

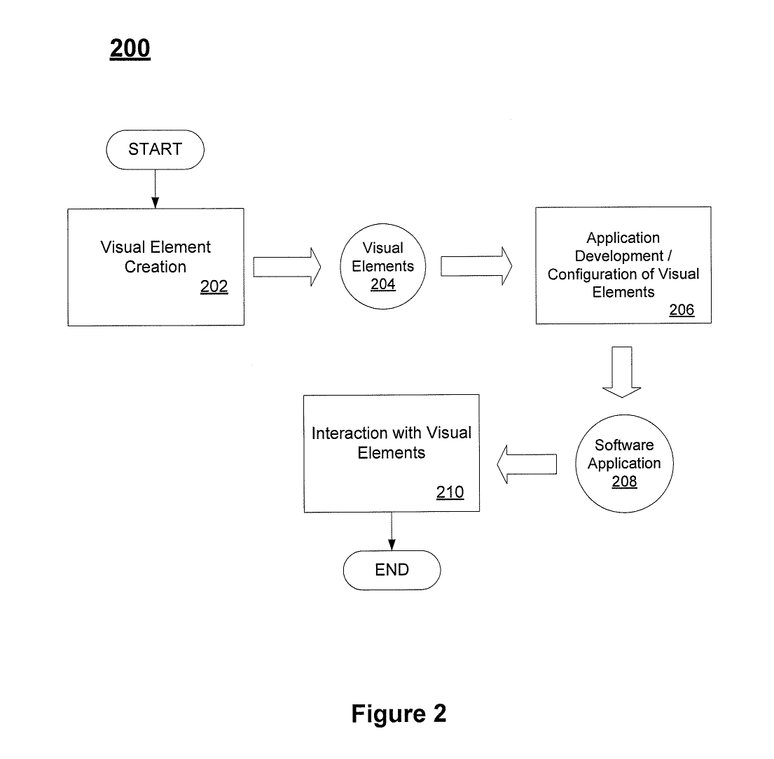

FIG. 2 is a block diagram illustrating exemplary creation and use of visual elements in the exemplary computing environment of FIG. 1. The visual elements 204 can be created and included in an SDK, e.g., by the toolkit creation device 50, at block 202. The visual elements 204 included in the SDK can be provided to, e.g., the IDE device 10, at block 206, where a software application 208 comprising the visual elements and their associated components can be created. The software application 208 can be executed by a device, e.g., the client device 40, at which time the visual elements associated with the software application can be interacted with by an end user of the software application 208 at block 210. The visual elements can be configured at run-time or compile-time according to various embodiments. The processes performed at each of these blocks will be explained in greater detail in the following paragraphs.

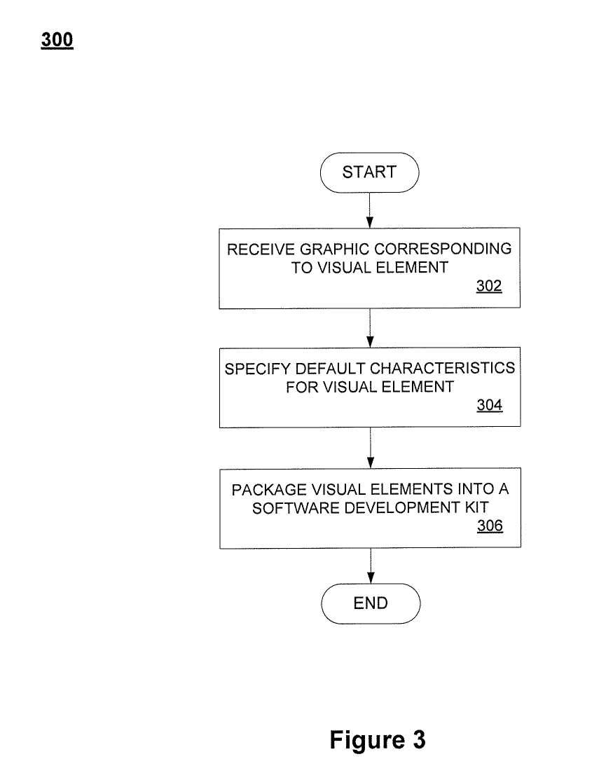

FIG. 3 is a flow chart illustrating a computer-implemented method for creating visual elements (block 202 of FIG. 2). At block 302, a graphic illustration of a visual element, e.g., a solid horizontal line for a row separator of a data grid, can be selected. In one embodiment, such a graphic can be created using graphical design software and exported using a recognizable format into the environment used to create the visual element, e.g., toolkit creation device 50.

Characteristics of a visual element can be specified during the creation of the visual element at block 304. In one embodiment, basic or primitive characteristics of a visual element, e.g., those fundamental characteristics that are shared by all visual elements, can be included in the class of a visual element during its creation. For example, all visual elements can share the characteristic of being locatable at a particular X, Y coordinate position on a layout or canvas area in an IDE. Characteristics in addition to fundamental, shared characteristics can also be specified during creation of a visual element. Embodiments herein, however, emphasize the specification of limited characteristics at creation time of a visual element to give content developers more flexibility in configuring the visual element.

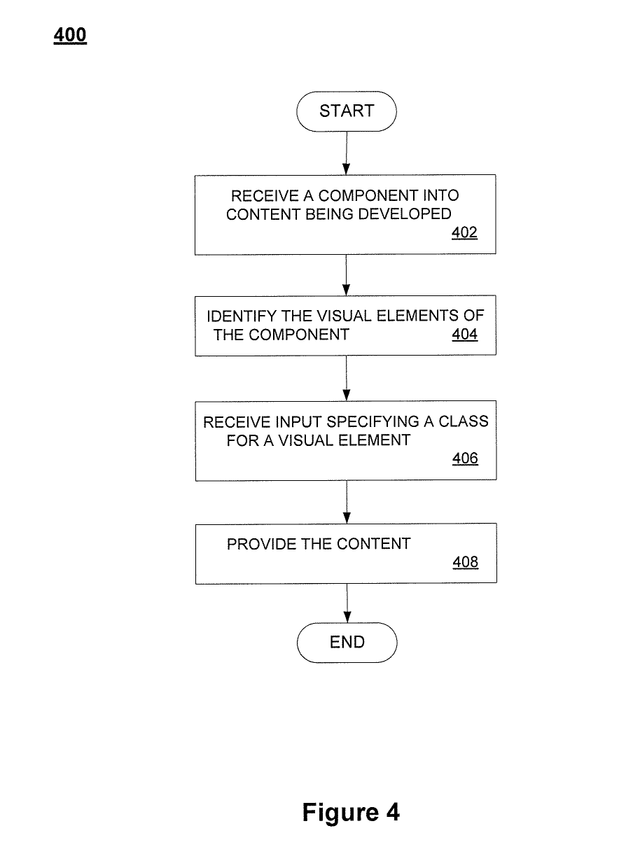

The visual elements created as described in the embodiment of FIG. 3 can be included in an SDK (block 306) and used to create a software application (block 206 of FIG. 2). The software application can be compiled program code or an interpreter of browser-executable content, as examples. Visual elements in an SDK can be considered to be associated with standard components that provide a certain level of default functionality for content developers. Content developers can additionally or alternatively create custom-built components and associated visual elements using an IDE, for example. FIG. 4 is a flow chart illustrating an exemplary computer-implemented method for configuring visual elements based on type and providing a software application containing the configurable visual elements to an end user. In one embodiment, the method can be performed by the devices shown in FIG. 1. At block 402, a component containing the visual elements can be received into content being developed. In one embodiment, the content is received into an IDE that can include a WYSIWYG interface 32 to assist content developers with creating a software application. In one embodiment, the content can be received in response to a content developer placing the component on a canvas area in the WYSIWYG interface 32 using a drag and drop operation.

The visual elements of the component received at block 402 can be identified at block 404. Content, such as program code or markup, that defines a type for visual elements can be displayed in the IDE when the component is received at block 302. The IDE can include, or alternatively provide access to, the various visual or interactive characteristics of the types that are available to be specified for visual elements in the IDE. Content developers can specify respective classes that correspond to these types for the visual elements so that the visual elements can inherit the visual or interactive characteristics of the specified classes (block 406).

Visual or interactive characteristics for a visual element can differ based on which type is specified for the visual element. Types can differ in a number of ways. For example, they can differ based on the characteristics available for configuration. For example, some types may have characteristics that enable an end user to interact with the appearance of a visual element, such as the handles located at corners of rows selected by the selection indicator visual element. Other types can have characteristics that display a message in response to end user actions, e.g., a hover indicator visual element type.

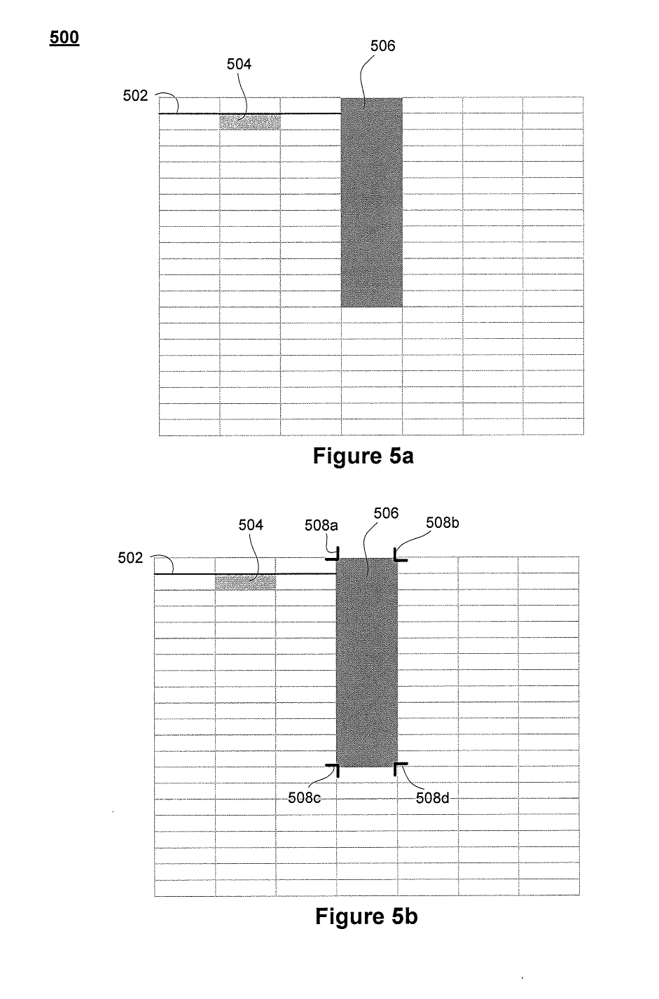

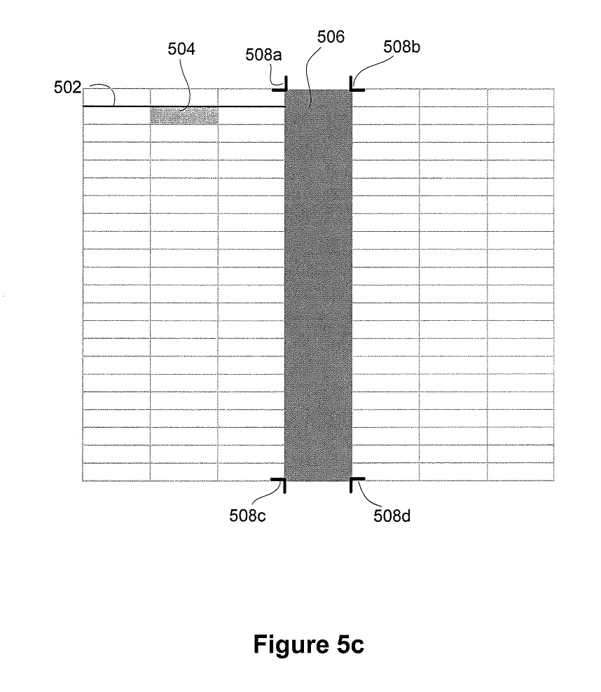

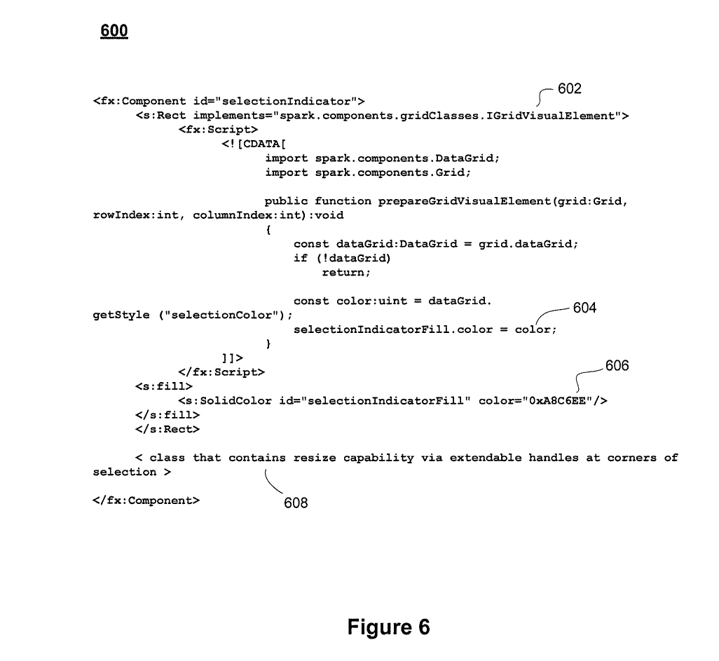

The content containing the configurable visual elements can be provided at block 408 of FIG. 3, which corresponds to block 210 of FIG. 2. In one embodiment, providing the content includes compiling the application containing the configurable visual elements into an executable application. An end user can download, install, and execute the application at a computer device, e.g., client device 40. The end user can then interact with the visual elements as explained in conjunction with FIG. 5b, FIG. 5c, and FIG. 6.

FIG. 5a depicts a data grid component that contains various visual elements, such as a row separator 502, an editor indicator 504, and a selection indicator 506. Fewer or more visual elements may exist for the data grid component. The data grid and its visual elements can be standard elements that can be used in an IDE where a type can be specified for them. For example, FIG. 6 illustrates program code and markup associated with the selection indicator 506. In one embodiment, the selection indicator 506 can include the IGridVisualElement class, as indicated by label 602. Such a class can provide primitive characteristics that can be shared by the row separator 502 and editor indicator 504, as well as other visual elements of the data grid component. In one embodiment, characteristics such as color (labels 604 and 606) can be included during creation of the selection indicator 506.

Content developers can specify a class 608 that enables the selection indicator 506 to be configured such that it can be expanded to highlight additional data. To accomplish this, according to one embodiment, specification of the type 608 can cause the selection indicator 506 to have handles 508a-d located at the corners of the selection indicator 506, as shown in FIG. 5b. Any of the handles 508a-d can be selected and extended generally in a direction in which additional selection is desired. For example, during run-time of a software application containing the data grid and a selection indicator 506, an end user can click on handle 508c and drag it in a vertical direction to increase the size of the selected area vertically, as shown in FIG. 5c. An end user can click on the handle 508c and increase the selected area horizontally by dragging it in a horizontal direction.

Prior to the specification of class 608, the selection indicator 506 would have been unable to expand as described. Only the colors as indicated by labels 604 and 606 could have been configured, for example. By creating the selection indicator 506 in such a way that enables content developers to specify a type for the selection indicator 506, content developers can choose to allow an end user to interact with the selection indicator 506 in the manner described above. Configuration of the selection indicator 506 as described is only one example of how a visual element can be configured. Additional visual elements and additional types of configurations can be implemented in various embodiments.

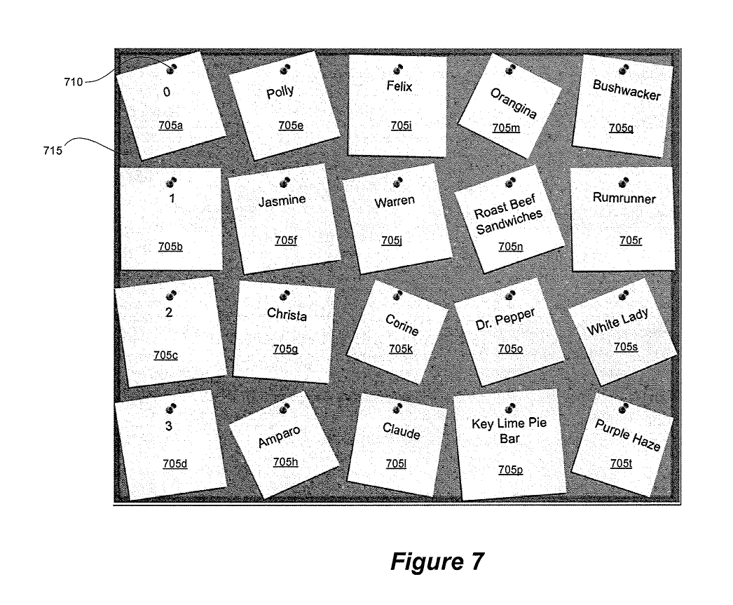

As another example, the appearance of cells in a data grid can be configured such that they appear as visual elements 705a-t in FIG. 7. As illustrated in FIG. 7, the visual elements can appear as note papers. The note papers in FIG. 7 appear to be help up to the board 715 by push pins, e.g., push pin visual element 710, at a location on the board 715 corresponding to their cell or cell-equivalent in the data grid. For example, the combination of note papers 705a, 705e, 705i, 705m, and 705q can represent a row of the data grid. Similarly, the combination of note papers 705a, 705b, 705c, and 705d can represent a column of the data grid. In one embodiment, an end user may interact with the push pin visual element 710 to move or reposition a note paper within the data grid. The illustration in FIG. 7 is merely an example of a specific configuration of a data grid that can be achieved by configuring its cell visual element. The cell visual element may have other appearances or characteristics, i.e., as determined by a type specified for the cell visual element, in other embodiments.

### General

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “receiving” and “identifying,” or the like, refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A method comprising:
receiving, at one or more processors, input specifying a component in content being developed, wherein the component, according to a definition of the component, comprises a visual element, the visual element being configurable based on a first type;
identifying a first set of characteristics of the visual element of the component based on the first type;
receiving, at one or more processors, a subsequent user input specifying a second type for the visual element;
identifying a second set of characteristics of the visual element based on the second type, wherein the second set of characteristics differs from the first set of characteristics; and
providing, via one or more processors, the content.

2. The method of claim 1 wherein the user input specifies a corresponding class for the visual element.

3. The method of claim 2 wherein the first set of characteristics and the second set of characteristics comprise visual or interactive characteristics, and wherein the visual or interactive characteristics are inherited from the specified class.

4. The method of claim 2, further comprising configuring the visual element based on visual or interactive characteristics of the specified class.

5. The method of claim 2 wherein the visual element is a selection indicator, wherein specifying the class for the selection indicator enables the selection indicator to be configured based on the size of an area associated with the selection indicator.

6. The method of claim 1 wherein the visual or interactive characteristics differ based on which characteristics are available.

7. The method of claim 1 wherein receiving input specifying a component, receiving user input specifying a second type, and providing the content occur via an integrated development environment (IDE).

8. The method of claim 1 wherein the user input specifying the second type comprises code associated with a markup language, the code enabling the configuration of the visual element based on type.

9. The method of claim 1 wherein at least one of the visual elements of a data grid can be configured based on type, wherein the configuration of the visual elements of a data grid comprises specifying at least one type of data grid visual element for another type of data grid visual element.

10. The method of claim 9 wherein the at least one type is a note paper visual element and the another type is a cell visual element, the cell visual element, in response to the specification of the at least one type, inheriting characteristics of the note paper visual element from a class associated with the note paper visual element.

11. A system comprising:
a processor;
a memory comprising instructions stored in computer readable medium that when executed by the processor provide operations comprising:
receiving a component specification as part of a software development kit (SDK), the component comprising a visual element that is configurable based on a first type;
receiving input specifying use of the component in content being developed;
identifying a first set of characteristics of the visual element based on the type;
receiving a subsequent user input specifying a second type for the visual element of the component in the content being developed;
identifying a second set of characteristics of the visual element based on the second type, wherein the first set of characteristics of the visual element differ from the second set of characteristics.

12. The system of claim 11, further comprising configuring the visual element based on the second set of characteristics associated with the second type.

13. The system of claim 11 wherein the component specification specifies that the second type can be received after the visual element has been included in the content being developed.

14. A non-transitory computer readable storage medium having computer-executable instructions for:
receiving input specifying a component in content being developed, wherein the component, according to a definition of the component, comprises a visual element, the visual element being configurable based on a first type;
receiving a subsequent user input specifying a second type for the visual element, wherein visual or interactive characteristics of the visual element available for specification in the IDE differ based on which type is specified for the visual element; and
providing the content.

15. The computer readable storage medium of claim 14 wherein the subsequent user input specifies a corresponding class for the visual element.

16. The computer readable storage medium of claim 15 wherein visual or interactive characteristics that can be configured are inherited from the specified class.

17. The computer readable storage medium of claim 15, further configuring the visual element based on the visual or interactive characteristics of the specified class upon receiving the subsequent user input.

18. The computer readable storage medium of claim 15 wherein the visual element is a selection indicator, wherein specifying the class for the selection indicator enables the selection indicator to be configured based on the size of an area selected by the selection indicator.

19. The computer readable storage medium of claim 14 wherein the visual or interactive characteristics differ based on which characteristics are available.

20. The computer readable storage medium of claim 14 wherein receiving input specifying a component, receiving the subsequent user input specifying a type, and providing the content occur via an IDE.

21. The computer readable storage medium of claim 14 wherein the subsequent user input comprises code associated with a markup language, the code enabling the configuration of the visual element based on type.
